(19) United States
(12) Patent Application Publication
(10) Pub. No.: US 2006/0172049 A1
(43) Pub. Date: Aug. 3, 2006

(54) Vegetable bag

(75) Inventors: Michael I. Silver, New York, NY (US); Wendy L. Silver, New York, NY (US)

Correspondence Address: FITZPATRICK CELLA HARPER & SCINTO, 30 ROCKEFELLER PLAZA, NEW YORK, NY, 10112, US

(73) Assignee: WENCO, L.L.C., Mount Kisco, NY (US)

(21) Appl. No.: 11/045,091

(22) Filed: Jan. 31, 2005

(51) Int. Cl. A23K 3/02

(52) U.S. Cl. 426/419

(57) ABSTRACT

Bag for storing vegetables constructed of a piece of a synthetic, absorbent cloth constructed of microfibers, the piece being formed in the shape of a bag having an opening for receiving the vegetables to be stored in the bag. At least one cord is secured to the piece of cloth at a position proximate to the opening, the cord having a length sufficient to tie around a portion of the bag proximate to the opening, when that portion of the bag is cinched, so as to close the opening and secure the vegetables stored in the bag. The bag does not substantially shield the vegetables stored in the bag from the ambient environment with any impermeable material positioned between the vegetables stored in the bag and the ambient environment.

### BACKGROUND OF THE INVENTION

Vegetables, including leafy greens, are commonly bought by consumers and stored in refrigerators until their use. Unfortunately, vegetables, particularly leafy greens, will not keep fresh for an extended period, even when stored in a refrigerator. The vegetables tend to wilt or soften after a time, leading a consumer to discard the remaining portions of the product. Commonly, the cause of the wilting or mushiness is water. With respect to leafy greens in particular, water that accumulates on the greens often promotes microbial growth. The microbial growth leads to the typical softening and wilting that occurs over time, particularly when stored for too long in a refrigerator.

Many available refrigerators include specialized drawers for storing greens. The drawers allow a consumer to control the humidity in a manner especially suited for vegetables. For instance, a consumer can lower the humidity level inside the drawer to reduce the likelihood that water accumulates on the vegetables.

However, when purchased by a consumer, vegetables often are transported and stored in impermeable plastic bags, which do not allow for adequate respiration and which trap liquids. Storing vegetables in such bags can lead to the pooling of water droplets on the vegetables. Consequently, the increased moisture on the vegetables promotes microbial growth and reduces the shelf life of the vegetables, even when a specialized drawer is used. This may lead to the wilting and softening of the vegetables more rapidly than preferred.

This problem is exacerbated when the vegetables are washed prior to being placed in the refrigerator. For example, if a consumer washes salad greens, but only uses some of the greens to make a salad, the remaining washed greens would likely be placed back in the refrigerator (often in an impermeable plastic bag or a cotton fiber bag). Unless thoroughly dried, water from the washing will remain on the greens, promoting microbial growth that would likely accelerate the wilting and softening of the greens. This reduces the time during which a user can use the stored greens.

To address this problem, a few conventional approaches have been proposed.

In one approach, impermeable plastics used for vegetable-storage bags have been formed to have small openings, which ventilate the contents of the bags to the ambient environment. An example of such an approach is described in U.S. Pat. No. 4,473,432 (Leader, et al.). That patent suggests forming the openings in impermeable plastic by (i) providing a thick weave of the plastic having crevices through which ventilation can occur, or (ii) forming sheets of impermeable plastic with perforations therethrough. These impermeable materials are then used to form bags for holding salad greens. The small openings through the impermeable plastic (whether crevices or perforations) allow for ventilation to the ambient environment, in order to allow for evaporation and reduce spoilage. The openings, however, may cause too much exposure to the ambient environment. In addition, at portions between the holes, the impermeable plastic can trap water between the plastic and the vegetables. Thus, there is room for improvement over such storage systems.

In another approach, a bag for storing greens is formed to have an outer layer of impermeable plastic having perforations therethrough, and an inner layer formed of a cloth. Examples of such bags are shown in U.S. Pat. Nos. 4,735,308 and 4,629,064 (both to Barner). The cloth inner layer is intended to absorb water, although respiration and drainage of the water to the ambient environment would still likely be controlled by the perforated, impermeable outer layer. Consequently, when excess water remains on the greens, the cloth liner may absorb the liquid to some extent, but may not be able to quickly wick the liquid away from the greens to the ambient environment because of the impermeable outer layer provided.

U.S. Pat. Nos. 5,880,044 (Shimiz) and 5,512,357 (Shimura, et al.) disclose specific synthetic cloths that absorb water. Those patents mention that the cloths can be used in the packaging and transport of greens. Those documents, however, do not describe reusable bags.

In both of the above-discussed approaches, bags formed of impermeable materials (although having some openings therethrough) are provided between the vegetables and the ambient environment. These impermeable materials limit the amount of liquid that can be drawn away from the greens. Consequently, there is room for improvement in the art.

The present inventors have overcome the drawbacks of the prior art by designing an improved bag for storing vegetables which does not separate the vegetables from the ambient environment with any impermeable plastic layer.

### SUMMARY OF THE INVENTION

The present invention is generally directed to a bag for storing vegetables. The bag includes a piece of synthetic, absorbent cloth constructed of microfibers, the piece of cloth being formed in the shape of a bag having an opening for receiving the vegetables to be stored therein. The bag does not substantially shield the stored vegetables from the ambient environment with any impermeable material positioned between the vegetables stored in the bag and the ambient environment.

In addition, the bag preferably includes securing means for securing the piece of cloth at a position proximate to the opening. The securing means should secure a portion of the bag proximate to the opening, when that portion of the bag is cinched, in order to close the opening and secure the vegetables stored in the bag. Preferably, the securing means is a cord secured to the piece of cloth. The cord preferably has a length sufficient to tie around the portion of the bag proximate to the opening.

In another embodiment, the present invention is directed to a method of storing vegetables. The method includes the steps of washing the vegetables with water, storing the vegetables in a bag, securing the bag in a closed position, and placing the closed bag in a refrigerator for storage. In this method, the bag in which the vegetables are stored includes a piece of synthetic, absorbent cloth constructed of microfibers, the piece being formed in the shape of a bag having an opening for receiving the vegetables to be stored therein. The bag does not substantially shield the vegetables from the ambient environment with any impermeable material positioned between the vegetables stored in the bag and the ambient environment. The bag also includes securing means for securing to the piece of cloth at a position proximate to the opening. The securing means should secure a portion of the bag proximate to the opening, when that portion of the bag is cinched, in order to close the opening and secure the vegetables therein.

The Cloth

The bag of the present invention is formed of a synthetic cloth, which may be woven or non-woven. Preferably, the cloth is woven of microfibers. The microfibers preferably have a denier of 0.03 to 0.1 dpf. In addition, the fibers may have capillary channels provided along their lengths, to aid in water absorption. In a most preferred embodiment, the microfibers are woven or stitched to form a terry or suede cloth. Consequently, the thus-formed cloth has a pile that adds to the absorptiveness of the bag. The pile is preferably formed by loops of the fine fibers which project up from at least one side of the cloth for approximately 1 to 2 mm to provide a soft nap.

Preferably, the pile of the cloth is such that the cloth scores less than a 1, and most preferably scores a 0, in the AATCC 79 test. In the AATCC 79 test, a drop of water is placed on the fabric, and the score is the number of seconds it takes for the fabric to absorb the drop. Accordingly, it is preferred that the fabric absorb a drop of water substantially immediately.

Also, it is preferred that the absorbency of the synthetic cloth for water is greater than about 60%, as measured by an AATCC 70 absorption test. More preferably, the absorbency is great than about 70%. Most preferably, the absorbency is about 80% or greater. In an AATCC 70 test, a piece of fabric is cut into 8″×8″ pieces (with each piece yielding a set of results), and the pieces are placed in a “Linger” device for about 20 minutes. The weight of each piece is compared to its weight before the process, such that (weight before process/weight after the process)×100=absorbency rate.

The microfibers are preferably formed of a mixture of polyester and nylon. Preferably, the mixture includes about 50 to about 85% polyester, and about 15 to about 50% nylon. Most preferably, the mixture is about 80% polyester and about 20% nylon.

The fibers and cloth may be formed by any one of a number of conventional manufacturing methods. Such methods would be readily understood by one of ordinary skill in the art. Accordingly, a description of possible manufacturing methods for forming the fibers and cloth is not provided herein.

The Shape

In our invention, the synthetic cloth (including a single piece or multiple pieces) may be formed into any bag shape that can hold vegetables.

Formation of a bag from a synthetic cloth may be accomplished using any of a number of conventional manufacturing methods, as would be appreciated by one of ordinary skill in the art. Consequently, a detailed description of many of such conventional methods is not provided herein.

Preferably, however, a single piece of the synthetic cloth is formed into a bag. Most preferably, the bag is formed of a single piece of cloth cut into a substantially rectangular shape. The rectangular shape may be folded substantially in half to form a smaller rectangle. Once folded, the folded cloth has three open edges. The open edges are the three sides of the smaller rectangle defined by the substantial alignment of pairs of loose edges of the cloth (i.e., the three sides of the smaller rectangle other than the side defined by the fold). For two of the three open edges of the smaller rectangle, the pairs of loose edges of the cloth are secured together to form one or more seams. The remaining open edge of the small rectangle, which does not have a seam, defines the opening of the bag such that the loose edges thereof serve as the rim of the opening.

Preferably, the seam (or seams) joining the substantially overlapping loose edges is formed by sewing those loose edges of cloth together so as to close the open edges of the smaller rectangle. Of course, any one of a number of conventional securing mechanisms may be used to form the seams.

With the preferred method of forming the bag from a single piece of rectangular cloth, the end product is a bag that is rectangularly-shaped when laid flat, with the opening being provided at one side of the rectangle. Preferably, the width of this rectangular bag is about 10 to about 14 inches, when laid flat. In addition, the preferred length of the bag is about 12 to about 20 inches, when laid flat. Those measurement can also substantially define the preferred length and width of the bag when not formed as a rectangle, as would be appreciated by one of ordinary skill in the art.

Closing Mechanism

It is preferred that the bag include a closing mechanism that can be used to secure the opening of the bag in a closed position, so as to contain the vegetables within the bag. Any one of a number of conventional securing mechanisms may be used, including for example cord mechanisms, snap-fastened mechanisms, and hook-and-loop fasteners.

Preferably, the securing mechanism is a cord for tying around the bag near the opening, when the cloth is cinched to close the opening. Specifically, it is preferred that the bag be closed by cinching together the cloth of the bag within a few inches of the opening. The cord may be used to tie around the cinched portion of the bag to secure the opening of the bag in the closed position to prevent the vegetables from falling out and to minimize the exposure the vegetables to the ambient environment. The cord may also be used to perform the cinching itself when positioned around the bag near the opening.

Preferably, the cord is secured to the bag about 1 to about 4 inches from the opening. When thus secured, the point at which the cord is secured may define a cinching point at which the cloth may be cinched to close the opening of the bag.

More preferably, two cords are provided on the bag. Most preferably, the two cords are both attached to the bag at positions near to each other. One cord may be used to extend around the bag in one direction and the other cord may extend around the bag in the other direction. Thus, the ends of the two cords may be tied together on a side of the bag substantially opposite their points of attachment so as to cinch the bag into the closed position and secure the same. In other embodiments, a single cord may be attached to the bag near the middle of its length, so that the two sides of the cord (separated by the point of attachment) may operate as two separate cords.

The cord or cords may be provided in any one of a number of lengths so as to operate to close the bag sufficiently. Preferably, each cord, or length of cord from the point of attachment to the bag to its end, is about 12 to about 14 inches long.

The Use

Thus constructed, a consumer may use the bag to help prolong the shelf life of vegetables, by lengthening the duration before which wilting and softening of the vegetables occurs. A user may employ the bag to store vegetables in any one of a number of circumstances. The user may transfer the vegetables to the bag after purchasing the vegetables. Thus, the vegetables can be removed from the impermeable plastic bag in which they were likely transported from the market and placed in the bag of the present invention before being first stored in the refrigerator. Alternatively, recently purchased (or picked) vegetables left over from a first use may be stored in the bag of the present invention to prolong the shelf-life of those unused vegetables until the next use.

Preferably, before placement in the bag, a user will first wash the vegetables thoroughly. The user may choose to dry the vegetables thoroughly or partially, or may choose not to dry the vegetables at all. The vegetables, perhaps still partially wet, may be placed in the bag. The securing mechanism, such as a cord, or the like, may be used to secure the opening of the bag in a closed position, thus trapping the vegetables within the bag. The consumer may then place the bag containing the vegetables in the refrigerator, in the specialized drawer provided for vegetables or elsewhere in the refrigerator. With the present invention, the absorbent, synthetic cloth absorbs excess moisture from the vegetables and transfers the same to the ambient environment, so as to prevent the pooling of liquid droplets on the vegetables, which could lead to the advancement of microbial growth.

In addition, the synthetic cloth allows for respiration, which would otherwise be impeded by an impermeable plastic. In the present invention, a material of impermeable plastic (whether such material is perforated or formed of a thick weave having openings therethrough) is not provided between the vegetables stored in the bag and the ambient environment. Such impermeable plastic layers/materials typically include materials substantially impermeable to water, except for through holes or perforations provided therethrough, and woven materials in which the weave is formed of thick pieces of impermeable materials. Most preferably, specifically not provided between the vegetables and the ambient environment are plastics (woven, perforated, or otherwise configured) with absorbencies less than about 60% by weight, as measured by the AATCC 70 absorption test.

### DESCRIPTION OF THE DRAWINGS

FIG. 1 is a plan view of a bag according to the present invention.

FIG. 2 is an elevation view of the bag shown in FIG. 1 in the closed position.

FIG. 3 is an elevation view of an end of a microfiber used in constructing the synthetic cloth of the present invention.

### DETAILED DESCRIPTION OF THE DRAWINGS

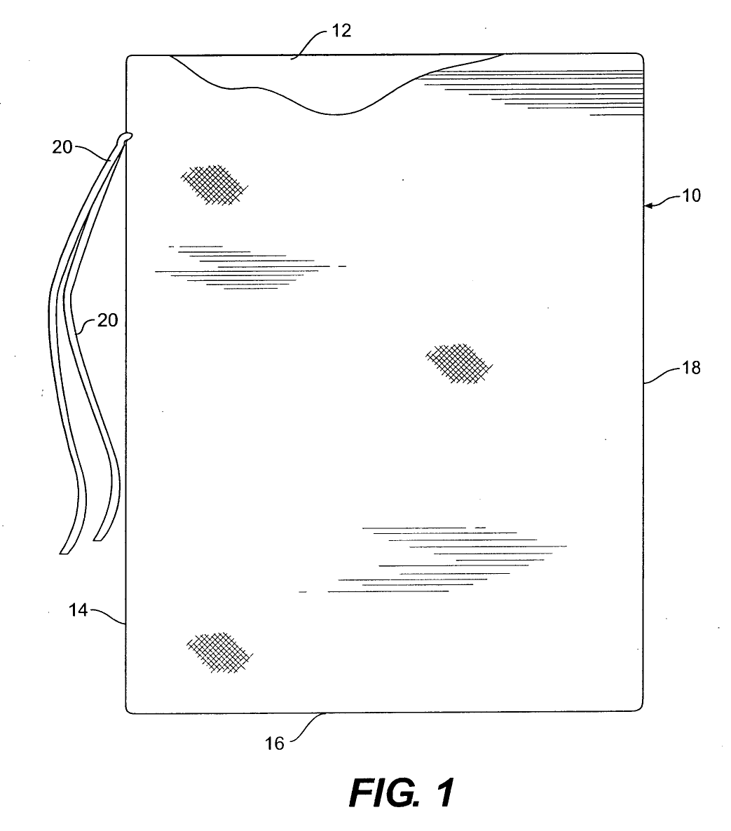

FIG. 1 shows a synthetic cloth bag 10. The cloth bag 10 is formed of a single piece of synthetic cloth substantially rectangular in shape. The cloth has been folded substantially in half to form the smaller rectangular shape shown in FIG. 1. Reference numeral 18 indicates the fold, which serves as a long side of the rectangular bag 10.

Sides 14 and 16 have a continuous seam from the corner formed by the intersection of sides 16 and 18 to the corner formed by the intersection of sides 12 and 14. The seam secures the overlapping loose edges of cloth formed when the cloth was folded in half. Reference numeral 12 indicates the opening of the bag, which is defined by the unsecured, loose edges of overlapping cloth formed when the cloth was folded.

Attached to the seam of side 14, below opening 12, are two cords 20.

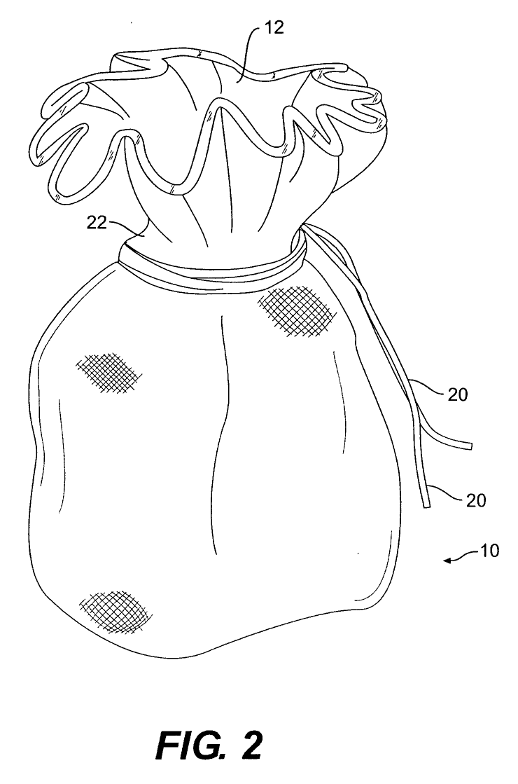

FIG. 2 shows bag 10 secured in a closed position with vegetables stored therein. Specifically, a portion of the cloth near opening 12 is cinched so as to form cinched portion 22. Cords 20 are wrapped around the cinched portion 22 and tied together so as to secure the cinched portion, and thus opening 12, in a closed position. Consequently, the vegetables are secured inside bag 10.

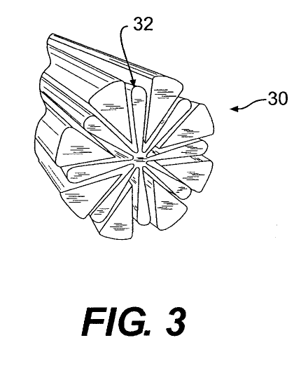

FIG. 3 shows an end (substantially a cross-section) of a microfiber 30 that is preferably used in forming the synthetic cloth of bag 10. Microfiber 30 has capillaries 32 along its length, which aid in the absorbency of the synthetic cloth. As shown, the cross-section of the microfiber 30 shows gaps that aid in the absorption of liquids. Preferably, the fibers are created by placing fillers within the fiber to create texture that increases the absorbency of liquids.

We claim:

1. A bag for storing vegetables, the bag comprising:
a piece of a synthetic, absorbent cloth constructed of microfibers, the piece being formed in the shape of a bag having an opening for receiving the vegetables to be stored in the bag; and
securing means for securing the piece of cloth so as to secure a portion of the bag proximate to the opening, when that portion of the bag is cinched, in order to close the opening and secure the vegetables stored in the bag,
wherein the bag does not substantially shield the vegetables stored in the bag from the ambient environment with any impermeable material positioned between the vegetables stored in the bag and the ambient environment.

2. A bag according to claim 1, wherein the piece of synthetic, absorbent cloth is rectangular and is secured in the shape of the bag such that the piece is folded substantially in half to form a smaller rectangle, with two of the three open edges of the smaller rectangle being secured together to form a seam, with the opening of the bag being defined by the remaining open edge of the rectangle.

3. A bag according to claim 1, wherein the bag is substantially rectangular in shape, when laid flat, with the width of the rectangle being about 10 to about 14 inches, and the length of the being about 12 to about 20 inches.

4. The bag according to claim 1, wherein the securing means comprises two cords for securing the bag in a closed position, wherein the two cords extend from adjacent positions on the bag, about 1 to about 4 inches from the opening, and the two cords are adapted to wrap around opposite sides of the bag and tie together so as to cinch the opening of the bag in the closed position.

5. The bag according to claim 1, wherein the microfibers have capillaries extending along the lengths thereof.

6. The bag according to claim 1, wherein the cloth has a soft nap.

7. The bag according to claim 1, wherein the absorbency of the cloth for water is greater than about 70%, as measured by an AATCC 70 absorption test.

8. The bag according to claim 1, wherein microfibers comprise a mixture of polyester and nylon.

9. The bag according to claim 8, wherein the microfibers comprise a mixture of about 80% polyester and about 20% nylon.

10. The bag according to claim 1, the cloth is woven as terry cloth.

11. The bag according to claim 1, wherein the cloth is woven as a suede cloth.

12. The bag according to claim 1, wherein the size of the microfibers is about 0.03 dpf to about 0.1 dpf.

13. The bag according to claim 1, wherein the impermeable plastic material is defined by a plastic material having an absorbency less than about 60%, as measured by an AATCC 70 absorption test.

14. A method of storing vegetables comprising the steps of:
washing the vegetables with water;
storing the vegetables in a bag, the bag comprising:
(i) a piece of a synthetic, absorbent cloth constructed of microfibers, the piece being formed in the shape of a bag having an opening for receiving the vegetables to be stored in the bag; and
(ii) securing means for securing the piece of cloth so as to secure a portion of the bag proximate to the opening, when that portion of the bag is cinched, in order to close the opening and secure the vegetables stored in the bag,
(iii) wherein the bag does not substantially shield the vegetables stored in the bag from the ambient environment with any impermeable material positioned between the vegetables stored in the bag and the ambient environment;
securing the bag in the closed position using the securing means; and
placing the closed bag in a refrigerator for storage.

15. The method according to claim 14, wherein the bag is substantially rectangular in shape, when laid flat, with the width of the rectangle being about 10 to about 14 inches, and the length of the being about 12 to about 20 inches.

16. The method according to claim 14, wherein the absorbency of the cloth for water is greater than about 70%, as measured by an AATCC 70 absorption test.

17. The method according to claim 14, wherein microfibers comprise a mixture of polyester and nylon.

18. The method according to claim 17, wherein the microfibers comprise a mixture of about 80% polyester and about 20% nylon.

19. The method according to claim 14, wherein the securing means comprises two cords for securing the bag in a closed position, wherein the two cords extend from adjacent positions on the bag, about 1 to about 4 inches from the opening, and the step of securing the bag in the closed position comprises wrapping the two cords around opposite sides of the bag and tying ends of the two cords together so as to cinch the opening of the bag in the closed position.

20. The method according to claim 14, wherein the size of the microfibers is about 0.03 dpf to about 0.1 dpf.

21. The method according to claim 14, wherein the impermeable plastic material is defined by a plastic material having an absorbency less than about 60%, as measured by an AATCC 70 absorption test.
